(19) United States
(12) Patent Application Publication
(10) Pub. No.: US 2024/0240275 A1
(43) Pub. Date: Jul. 18, 2024

(54) METHOD FOR MANUFACTURING DIRECT REDUCED IRON AND DRI MANUFACTURING EQUIPMENT

(71) Applicant: ArcelorMittal, Luxembourg (LU)

(72) Inventors: George TSVIK, Valparaiso, IN (US); Dmitri BOULANOV, East Chicago, IN (US); Jon REYES RODRIGUEZ, AVILES Asturias (ES); Odile CARRIER, Metz (FR); Sarah SALAME, Maizieres les Metz (FR); José BARROS LORENZO, Maizieres les Metz (FR); Marcelo ANDRADE, East Chicago, IN (US); Dennis LU, East Chicago, IN (US)

(21) Appl. No.: 18/559,905

(22) PCT Filed: May 18, 2021
(86) PCT No.: PCT/IB2021/054252

§ 371 Date: Nov. 9, 2023

(51) Int. Cl. C21B 13/00; C21B 13/02

(52) U.S. Cl. CPC C21B 13/0073; C21B 13/02; C21B 2100/26; C21B 2100/44

(57) ABSTRACT

A method for manufacturing Direct Reduced Iron wherein iron ore is reduced in a DRI shaft by a reducing gas including hydrogen obtained by extraction from coke oven gas through a hydrogen separation unit, the remaining part of such coke oven gas being at least partly injected in the transition section of said DRI shaft to set the carbon amount of said Direct Reduced Iron from 0.5 to 3 wt. % and a DRI manufacturing equipment including a DRI shaft (1) and a hydrogen separation unit (5), wherein said hydrogen separation unit (5) inlet is connected to a coke oven gas supply (6) and includes a first outlet connected to the DRI shaft to inject hydrogen separated from said coke oven gas and a second outlet connected to the transition section of said DRI shaft (1) to inject at least part of the remaining part of such coke oven gas.

The invention is related to a method for manufacturing Direct Reduced Iron (DRI) and to a DRI manufacturing equipment.

### BACKGROUND

### Summary of the Invention

Steel can be currently produced through two main manufacturing routes. Nowadays, most commonly used production route consists in producing pig iron in a blast furnace, by use of a reducing agent, mainly coke, to reduce iron oxides. In this method, approx. 450 to 600 kg of coke, is consumed per metric ton of pig iron; this method, both in the production of coke from coal in a coking plant and in the production of the pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (Hot Direct Reduced Iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces.

There are three zones in each direct reduction shaft with cold DRI discharge: Reduction zone at top, transition zone at the middle, cooling zone at the cone shape bottom. In hot discharge DRI, this bottom part is used mainly for product homogenization before discharge.

Reduction of the iron oxides occurs in the upper section of the furnace, at temperatures up to 950° C. Iron oxide ores and pellets containing around 30% by weight of Oxygen are charged to the top of a direct reduction shaft and are allowed to descend, by gravity, through a reducing gas. This reducing gas is entering the furnace from the bottom of reduction zone and flows counter-current from the charged oxidised iron. Oxygen contained in ores and pellets is removed in stepwise reduction of iron oxides in counter-current reaction between gases and oxide. Oxidant content of gas is increasing while gas is moving to the top of the furnace.

The reducing gas generally comprises hydrogen and carbon monoxide (syngas) and is obtained by the catalytic reforming of natural gas. For example, in the so-called MIDREX method, first methane is transformed into a reformer according to the following reaction to produce the syngas or reduction gas:

$$C H 4 + C O 2 -> 2 C O + 2 H 2$$

and the iron oxide reacts with the reduction gas, for example according to the following reactions:

$$3 F e 2 O 3 + C O / H 2 -> 2 F e 3 O 4 + C O 2 / H 2 O$$

$$F e 3 O 4 + C O / H 2 -> 3 F e O + C O 2 / H 2 O$$

$$F e O + C O / H 2 -> F e + C O 2 / H 2 O$$

At the end of the reduction zone the ore is metallized.

A transition section is found below the reduction section; this section is of sufficient length to separate the reduction section from the cooling section, allowing an independent control of both sections. In this section carburization of the metallized product happens. Carburization is the process of increasing the carbon content of the metallized product inside the reduction furnace through following reactions:

$$3 F e + C H 4 \to F e 3 C + 2 H 2 ( Endothermic )$$

$$3 F e + 2 C O \to F e 3 C + C O 2 ( Exothermic )$$

$$3 F e + C O + H 2 \to F e 3 C + H 2 O ( Exothermic )$$

Injection of natural gas in the transition zone is using sensible heat of the metallized product in the transition zone to promote hydrocarbon cracking and carbon deposition. Due to relatively low concentration of oxidants, transition zone natural gas is more likely to crack to H₂ and Carbon than reforming to H₂ and CO. Natural gas cracking provides carbon for DRI carburization and, at the same time adds reductant (H₂) to the gas that increases the gas reducing potential.

In view of the considerable increase in the concentration of CO₂ in the atmosphere since the beginning of the last century and the subsequent greenhouse effect, it is essential to reduce emissions of CO₂ where it is produced in a large quantity, and therefore in particular during DRI manufacturing.

Based on the above, there is a need for a method of manufacturing Direct Reduced Iron that is CO₂-neutral, environmentally friendly and easy to implement, while showing a good yield.

This problem is solved by a method for manufacturing Direct Reduced Iron wherein iron ore is reduced in a DRI shaft by a reducing gas comprising hydrogen obtained by extraction from coke oven gas through a hydrogen separation unit, the remaining part of such coke oven gas being at least partly injected in the transition section of said DRI shaft to set the carbon amount of said Direct Reduced Iron from 0.5 to 3 wt. %.

The method of the invention may also comprise the following optional characteristics considered separately or according to all possible technical combinations:
the reduction gas further comprises top gas exiting the DRI shaft, which is mixed with said hydrogen obtained by extraction from coke oven gas,
the reduction gas further comprises additional reductant gas to be selected among hydrogen and biogas, which is mixed with said hydrogen obtained by extraction from coke oven gas,
the such reduction gas is being heated after mixing,
the heating of the reducing gas is being done by using CO2 neutral electricity,
the reducing gas is being injected in the DRI shaft in its reduction section,
the top gas coming from said DRI shaft is being scrubbed to remove water before being mixed into said reducing gas,
the remaining part of such coke oven gas is being partly injected in the cooling section of said DRI shaft,
the carbon content of the Direct Reduced Iron is set from 1 to 2 wt. %.

In the frame of the present invention, Direct Reduced Iron covers so-called DRI, but also hot briquetted iron (HBI), Cold Direct Reduced iron (CDRI) and Hot Direct Reduced Iron (HDRI). Such material can be later used in different processes, like, for example, processes to produce pig iron in a blast furnace or steel in a BOF or in an electric arc furnace. It can be also used as a combustible or as an electrode in a battery.

The invention is also related to a DRI manufacturing equipment including a DRI shaft and a hydrogen separation unit, wherein said hydrogen separation unit inlet is connected to a coke oven gas supply and includes a first outlet connected to the DRI shaft to inject hydrogen separated from said coke oven gas and a second outlet connected to the transition section of said DRI shaft to inject at least part of the remaining part of such coke oven gas.

The equipment may also comprise the following optional characteristics considered separately or according to all possible technical combinations:
a mixer comprising a first inlet connected to said first outlet of said hydrogen separation unit and a second inlet connected to the top gas outlet of said DRI shaft is provided,
the mixer includes a third inlet connected to an additional reductant gas supply,
the mixer is connected to the reduction section of said DRI shaft,
a scrubber connected to the top gas outlet of said DRI shaft is provided.

### BRIEF DESCRIPTION OF THE DRAWINGS

Other characteristics and advantages of the invention will emerge clearly from the description of it that is given below by way of an indication and which is in no way restrictive, with reference to the appended FIGURES in which:

FIG. 1 illustrates a DRI manufacturing equipment according to the invention.

### DETAILED DESCRIPTION

Elements in the FIGURE are illustration and may not have been drawn to scale.

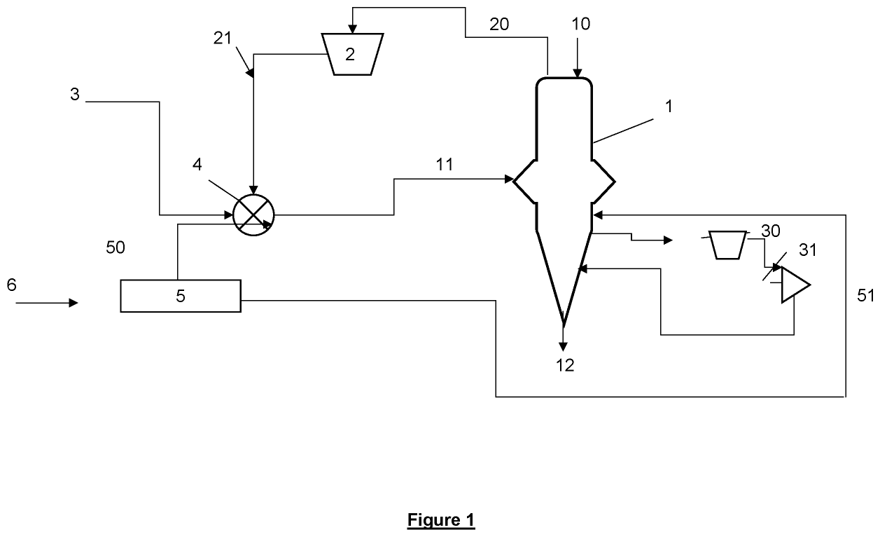

FIG. 1 is a schematic view of a DRI manufacturing equipment according to the invention. The DRI manufacturing equipment includes a DRI shaft 1 comprising from top to bottom an inlet for iron ore 10 that travels through the shaft by gravity, a reduction section located in the upper part of the shaft, a transition section located in the midpart of the shaft, a cooling section located at the bottom and an outlet 12 from which the direct reduced iron is finally extracted.

On top of the shaft, the top gas exiting the DRI shaft is collected in a pipe 20 which can optionally be connected to a scrubber 2 located on the top gas outlet of the DRI shaft. The top gas exiting from the DRI shaft usually comprises H₂, CO, CH₄, H₂O, CO₂ and N₂ in various proportions. The top gas scrubbing operation allows removing water vapor from the rest of the stream to improve its reduction potential.

In a preferred embodiment, after scrubbing, the top gas comprises from 40 to 75 vol % of H₂, from 0 to 30 vol % of carbon monoxide CO, from 0 to 10 vol % of methane CH₄, from 0 to 25 vol % of carbon dioxide CO₂, up to 5 vol % of H₂O, the remainder being nitrogen N₂. It is preferred to have, after scrubbing, a ratio of H₂/N₂ from 1.5 to 3 in such top gas.

Once the top gas exits the scrubber 2, it can optionally be compressed and can either be sent back to the DRI shaft or sent to one of the inlets of a mixer 4 through a connecting pipe 21.

Another inlet of said mixer 4 can be connected to a reduction gas supply 3. Such reduction gas can consist in hydrogen or in a hydrocarbon gas, like methane for example. In a preferred embodiment, the hydrogen supply is fed with green hydrogen produced without CO₂ emission, for example by water or steam electrolysis that can be powered with CO₂ neutral electricity.

CO₂ neutral electricity includes notably electricity from renewable source but can encompass the use of electricity coming from nuclear sources as it is not emitting CO₂ to be produced. CO₂ from renewable source is defined as energy that is collected from renewable resources, which are naturally replenished on a human timescale, including sources like sunlight, wind, rain, tides, waves, and geothermal heat.

In another embodiment, the reductant gas supply consists in a biogas, which is a renewable energy source that can be obtained by the breakdown of organic matter in the absence of oxygen inside a closed system called bioreactor. Biogas can be produced from raw materials such as agricultural waste, manure, municipal waste, plant material, sewage, green waste, food waste or any biodegradable materials. A preferred bio gas is for example biomethane.

A third inlet of the mixer 4 is connected to the outlet of a separation unit 5. Such separation unit 5 is connected to a Coke Oven gas supply 6. Coke oven gas composition is usually comprising 3 to 6 vol % of CO, 1 to 5 vol % of CO₂, 36 to 62 vol % of H₂, 16 to 27 vol % of CH₄, the remainder being nitrogen. Coke oven is produced as a by-product of the coke production and is usually used to fire the coke oven battery or simply burned. In most cases, its further use results in CO₂ emissions in the atmosphere.

The separation unit 5 allows extracting hydrogen from such stream and sending such hydrogen to the mixer 4 through a connecting pipe 50.

The separation unit can be based on any suitable industrial process of separation of gases, like physical and chemical absorption processes, adsorption processes or membrane processes.

In a preferred embodiment, the separation unit is a Pressure Swing Adsorption (PSA).

In another embodiment, the separation unit is a membrane, preferably a ceramic microporous membrane.

The reduction gas produced in the mixer 4 through the addition of the top gas, additional reductant gas and hydrogen from Coke Oven Gas, can optionally be heated through heating means provided to the mixer, such heating means being for example preferably powered by CO₂ neutral electricity or by burning a part of the coke oven gas. In a preferred embodiment, the temperature of the reduction gas is set to a range from 700° ° C. to 1000° C., preferably from 800 to 1000° C.

This reduction gas is then sent back to the DRI shaft, preferably in its reduction section through a pipe 11.

Coming back to the separation unit 5, the remaining part of the gas obtained after extraction of the hydrogen, is being sent back to the transition section of the DRI shaft 1 through a connecting pipe 51.

The injection of this gas is made to increase the carbon content of the Direct Reduced Iron to a range from 0.5 to 3 wt. %, preferably from 1 to 2 wt. % which allows getting a Direct Reduced Iron that can be easily handled and that keeps a good combustion potential for its future use.

The DRI manufacturing equipment may further comprise a recycling loop in the cooling section that allows extracting part of the gas present at that level to send it in a scrubber 30 and in a compression unit 31 before reinjecting it in the shaft 1.

In a preferred embodiment, part of the gas transported in the connection pipe 51 can be injected in such recycling loop of the cooling section after the compression unit to allow increasing the carbon content of the Direct Reduced Iron in the cooling section as well.

It is also possible to inject part of the gas transported in the connection pipe 51 in the reduction section of the DRI shaft, as such gas has a reduction power thanks to its content in CO and remaining H₂.

By using the method according to the invention, Direct Reduced Iron can be manufactured with the appropriate quality and yield, while remaining CO₂ neutral and taking optimal advantage of the gas co-product from coke manufacturing. It also allows decreasing the use of fossil energy like natural gas.

What is claimed is:

1-14. (canceled)

15: A method for manufacturing Direct Reduced Iron, the method comprising:
reducing iron ore is reduced in a DRI shaft by a reducing gas including hydrogen obtained by extraction from coke oven gas through a hydrogen separation unit; and
at least partly injecting a remaining part of the coke oven gas in a transition section of the DRI shaft to set the carbon amount of the Direct Reduced Iron in a range from 0.5 to 3 wt. %.

16: The method as recited in claim 15 wherein the reducing gas further includes top gas exiting the DRI shaft, the top gas being mixed with the hydrogen obtained by extraction from coke oven gas.

17: The method as recited in claim 15 wherein the reducing gas further includes additional reducing gas selected from the group consisting of hydrogen and biogas, the additional reducing gas being mixed with the hydrogen obtained by extraction from coke oven gas.

18: The method as recited in claim 15 wherein the reducing gas further includes either (1) top gas exiting the DRI shaft, the top gas being mixed with the hydrogen obtained by extraction from coke oven gas or (2) additional reducing gas selected from the group consisting of hydrogen and biogas, the additional reducing gas being mixed with the hydrogen obtained by extraction from coke oven gas,
wherein the reducing gas is heated after being mixed.

19: The method as recited in claim 18 wherein the heating of the reducing gas is performed by using CO₂ neutral electricity.

20: The method as recited in claim 15 wherein the reducing gas is injected in the DRI shaft in a reduction section.

21: The method as recited in claim 15 wherein the top gas coming from the DRI shaft is scrubbed to remove water before being mixed into the reducing gas.

22: The method as recited in claim 15 wherein a remaining part of such coke oven gas is partly injected in a cooling section of the DRI shaft.

23: The method as recited in claim 15 wherein the carbon content of the Direct Reduced Iron is set from 1 to 2 wt. %.

24: DRI manufacturing equipment comprising:
a DRI shaft; and
a hydrogen separation unit having an inlet connected to a coke oven gas supply and including a first outlet connected to the DRI shaft to inject hydrogen separated from coke oven gas from the coke oven gas supply and a second outlet connected to a transition section of said DRI shaft to inject at least part of a remaining part of the coke oven gas.

25: The DRI equipment as recited in claim 24 further comprising a mixer including a first inlet connected to the first outlet of the hydrogen separation unit and a second inlet connected to a top gas outlet of the DRI shaft.

26: The DRI equipment as recited in claim 25 wherein the mixer includes a third inlet connected to an additional reducing gas supply.

27: The DRI equipment as recited in claim 25 wherein the mixer is connected to a reduction section of the DRI shaft.

28: The DRI equipment as recited in claim 24 further comprising a scrubber connected to a top gas outlet of the DRI shaft.
